(19) United States
(12) Patent Application Publication
(10) Pub. No.: US 2005/0198816 A1
(43) Pub. Date: Sep. 15, 2005

(54) Fixing apparatus

(76) Inventors: Ling-Hsi Chao, Lujhu Township (TW); Lei-Lung Tsai, Sinjhuang (TW)

Correspondence Address: RATNERPRESTIA, P O BOX 980, VALLEY FORGE, PA, 19482-0980, US

(21) Appl. No.: 11/079,721

(22) Filed: Mar. 14, 2005

(30) Foreign Application Priority Data
Mar. 15, 2004 (TW) 93203894

(51) Int. Cl. B23P 19/00; H02G 3/08

(52) U.S. Cl. 29/739; 174/52.1; 439/545; 29/729

(57) ABSTRACT

An apparatus for assembling a device, which is formed with a through hole, onto a substrate includes a first engaging unit and a second engaging unit. The first engaging unit coupling with the substrate includes a protrusion defining an accommodation space. The second engaging unit includes a body and an engaging part connecting to the body. When the device and the substrate are assembled, the protrusion of the first engaging unit passes through the through hole of the device, and the engaging part of the second engaging unit is received in the accommodation space. Therefore, the device is fixed between the body of the second engaging unit and the substrate.

### CROSS REFERENCE TO RELATED APPLICATIONS

This application claims the right of priority based on Taiwan Patent Application No. 093203894 entitled “Fixing Apparatus”, filed on Mar. 15, 2004, which is incorporated herein by reference and assigned to the assignee herein.

### FIELD OF THE INVENTION

The present invention generally relates to a fixing apparatus, and more particularly to an apparatus for assembling a device onto a substrate.

### BACKGROUND OF THE INVENTION

An electronic device generally includes layers of components or devices assembled together. Screws and screwdrivers are often used as fixing tools. As the technology continuously advances, the electronic devices are advancing to smaller and thinner dimensions. Accordingly, the conventional fixing accessories, such as screws, are no longer suitable and are inconvenient to assemble or disassemble the electronic device.

When assembling film-like devices, such as multiple layers of film-type circuitry of a keyboard or optical films of a backlight module, using screw-type fixing means will be time-consuming in production, and screw-type fixing means is not an ideally detachable fixing apparatus for film-like devices. Moreover, as the electronic devices become smaller and thinner, it is desirable to provide a fixing apparatus free of screws to assemble such a device onto a substrate.

### SUMMARY OF THE INVENTION

An object of the invention is to provide a fixing apparatus for assembling a device onto a substrate in a swift way so as to reduce the assembly time and the cost.

Another object of the present invention is to provide a fixing apparatus suitable for use in electronic devices, such as keyboards, backlight modules, or the like, so as to improve the reduction in thickness of electronic devices.

In a first embodiment of the present invention, an apparatus for assembling a device, which is formed with a through hole, onto a substrate includes a first engaging unit and a second engaging unit. The first engaging unit coupling to the substrate includes a protrusion, which defines an accommodation space. The second engaging unit includes a body and an engaging part, which connects to the body. When the device and the substrate are to be assembled, the protrusion of the first engaging unit passes through the through hole of the device, and the engaging part of the second engaging unit is received in the accommodation space so that the device is fixed between the body of the second engaging unit and the substrate.

Moreover, the accommodation space can be a hole formed in the protrusion. In an exemplary embodiment, the first engaging unit and the substrate are integrally formed. The body of the second engaging unit can be formed with an opening, and the second engaging unit further includes a resilient part coupling to the body. When the device and the substrate are to be. assembled, the resilient part touches against the device via the opening. Additionally, the resilient part includes a hook-like portion, which touches against the device so as to restrain the movement of the protrusion of the first engaging unit. The second engaging unit further includes an extension part extending from the body so as to restrain the movement of the device.

In a second embodiment of the present invention, an apparatus for assembling a device, which is formed with a through hole, onto a substrate includes a first engaging unit and a second engaging unit. The first engaging unit coupling to the substrate includes a protrusion with an inner rim, which defines a first accommodation space and a second accommodation space. The second engaging unit includes a body and an engaging part, which connects to the body. When the device and the substrate are to be assembled, the engaging part passes through the through hole of the device into the first accommodation space and then rotates along the inner rim to be received in the second accommodation space so that the device is fixed between the body of the second engaging unit and the substrate.

Furthermore, the inner rim of the protrusion in the second embodiment includes an arc portion and a straight portion. The straight portion corresponds to the arc portion and limits the engaging part of the second engaging unit to rotating along the arc portion. Moreover, the engaging part of the second engaging unit includes an engaging body and a wing. The engaging body connects to the body, and the wing is engaged within the second accommodation space. The engaging part of the second engaging unit is elastically deformable, so that the wing can escape from the second accommodation space to be in the first accommodation space when the first engaging unit, the device, and the second engaging unit are to be detached.

In a third embodiment, an apparatus for assembling a device, which is formed with a through hole, onto a substrate is provided. The apparatus includes a first engaging unit and a second engaging unit. The first engaging unit couples to the substrate and includes a deformable protrusion. The second engaging unit includes a body defining an opening. When the device and the substrate are assembled, the deformable protrusion of the first engaging unit passes through the through hole of the device and is exposed within the opening of the second engaging unit, and then the deform able protrusion can be deformed to limit the movement of the device so that the device is fixed between the body of the second engaging unit and the substrate.

Furthermore, the first engaging unit of the third embodiment includes a base coupled with the substrate. The deformable protrusion can be a hook-like portion protrudently extending from the base. When the device and the substrate are to be assembled, the hook-like portion is bent to an angle so as to touch against the device.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIGS. 1A and 1B are schematic views illustrating the elements of an apparatus for assembling a device onto a substrate in accordance with a first embodiment of the present invention, when the elements are detached and assembled, respectively;

FIGS. 1C and 1D are schematic views illustrating the modified second engaging units in accordance with the first embodiment;

FIGS. 2A and 2B are schematic views illustrating the modified elements of an apparatus for assembling a device onto a substrate in accordance with the first embodiment of the present invention, when the elements are detached and assembled, respectively;

FIG. 3A is a schematic view illustrating the elements of an apparatus for assembling a device onto a substrate in accordance with a second embodiment of the present invention, when the elements are detached;

FIGS. 3B and 3C are a cross-sectional view and a top view respectively of the apparatus for assembling the device onto the substrate in accordance with the second embodiment of the present invention;

FIG. 3D is a top view illustrating the modified elements of an apparatus for assembling a device onto a substrate in accordance with the second embodiment of the present invention; and

FIGS. 4A and 4B are schematic views illustrating the elements of an apparatus for assembling a device onto a substrate in accordance with a third embodiment of the present invention, when the elements of the apparatus are detached and assembled, respectively.

### DETAILED DESCRIPTION OF THE INVENTION

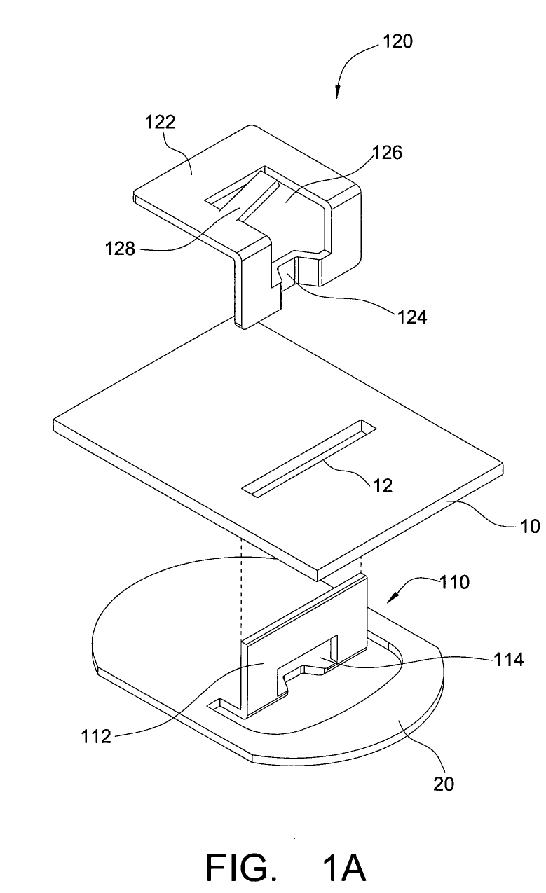

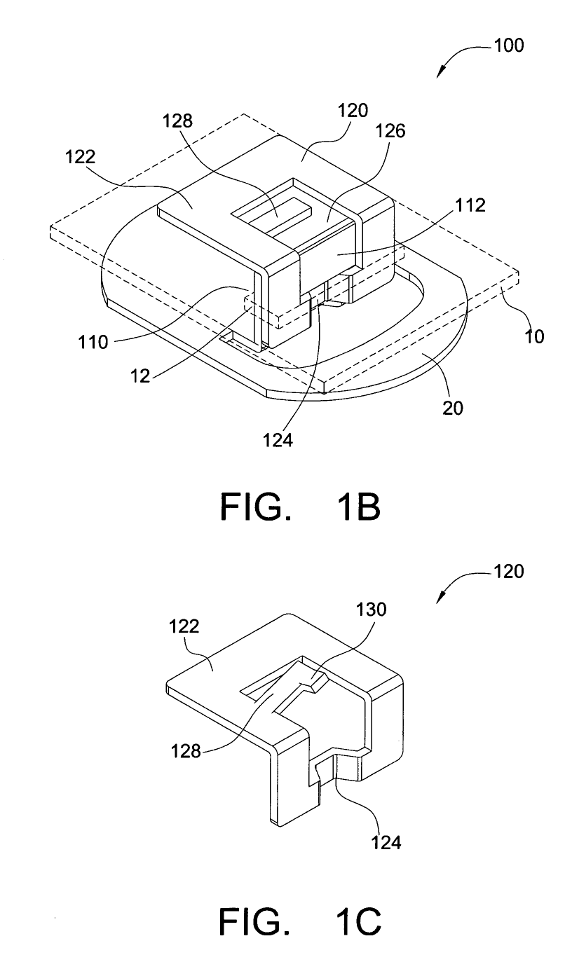

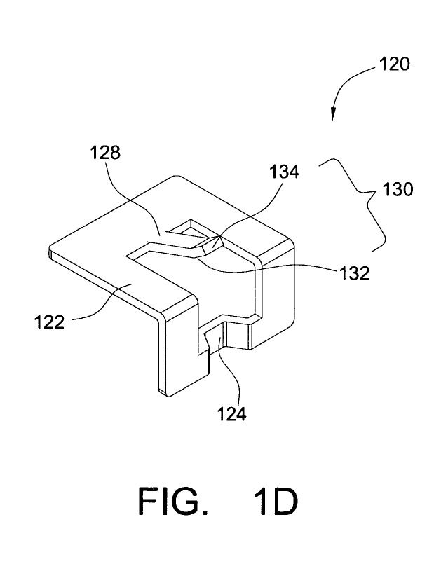

The present invention provides an apparatus for assembling a device onto a substrate in a swift way, i.e. without using a screwdriver and any screws. The fixing apparatus of the present invention is suitable for use in electronic devices so as to improve the reduction in thickness of the electronic devices. Preferred embodiments of the present invention are illustrated in FIGS. 1 to 4.

Referring to FIGS. 1A and 1B, the present invention provides an apparatus 100, in accordance with a first embodiment, for assembling a device 10 onto a substrate 20. The device 10 is formed with a through hole 12 and can be, for example, a circuit film of a keyboard, a reflective plate of a backlight module, or any film-like device as appropriate. The substrate 20 can be a housing of a keyboard or other electronic devices, but can also be other components of an electronic device to be assembled with the device 10. The apparatus 100 includes a first engaging unit 110 and a second engaging unit 120. The first engaging unit 110 couples to the substrate 20. The first engaging unit 110 includes a protrusion 112, which defines an accommodation space 114. The second engaging unit 120 includes a body 122 and an engaging part 124, which connects to the body 122. As shown in FIG. 1A, the first engaging unit 110 and the substrate 20 are integrally formed, and the protrusion 112 is protrudent from the substrate 20. In other words, the first engaging unit 110 of the apparatus 100 can be designed as a part of the substrate 20 by bending a portion of the substrate 20 or by using an injection molding process so that the protrusion 112 protruding from the substrate 20 is formed and integrally connected to the substrate 20. Furthermore, the accommodation space 114 can be a hole formed in the protrusion 112. For example, the protrusion 112 is formed with a rectangular hole, which is configured to accommodate the engaging part 124 of the second engaging unit 120.

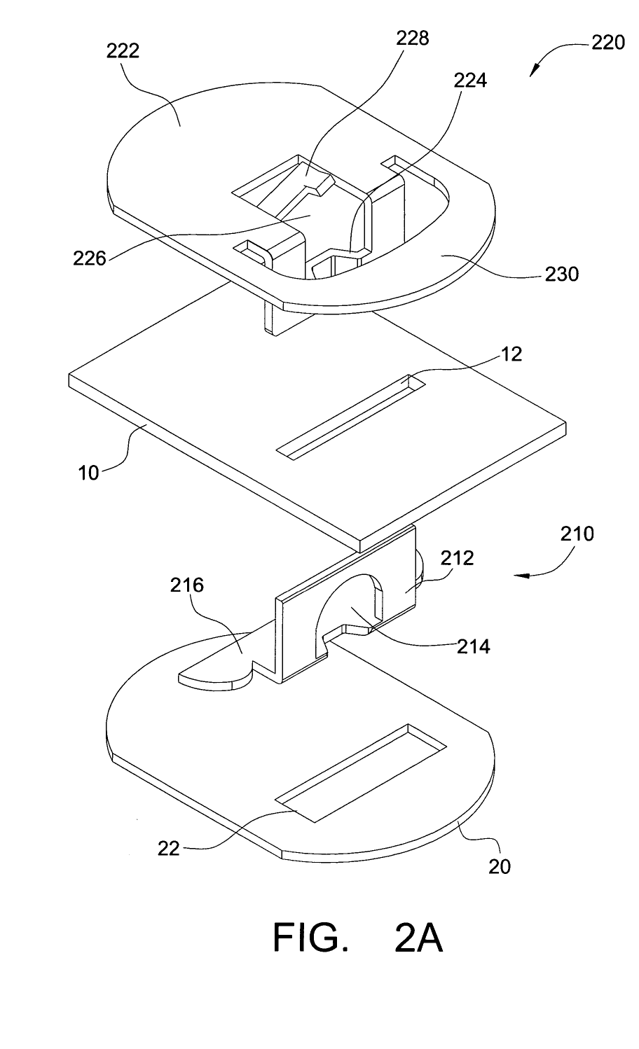

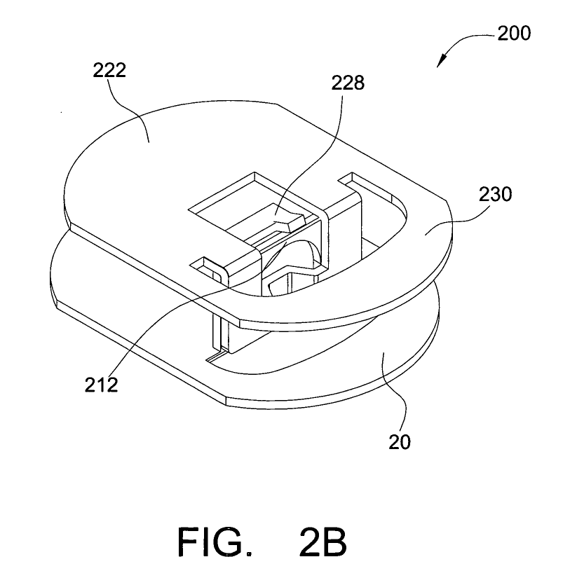

Referring to FIG. 2B, when the device 10 and the substrate 20 are to be assembled, the protrusion 112 of the first engaging unit 110 passes through the through hole 12 of the device 10, and the engaging part 124 of the second engaging unit 120 is received in the accommodation space 114 so that the device 10 is fixed between the body 122 of the second engaging unit 120 and the substrate 20. In this exemplary embodiment, the engaging part 124 is a portion of the body bent downward, which also includes an engaging end corresponding to the accommodation space 114 of the first engaging unit 110. When the first engaging unit 110 and the second engaging unit 120 are engaged, the engaging end of the engaging part 124 inserts into the hole 114 of the protrusion 112, and thereby assembling the device 10 onto the substrate 20.

Furthermore, the body 122 of the second engaging unit 120 defines an opening 126. The second engaging unit 120 further includes a resilient part 128 coupling to the body 122. When the device 10 is assembled on the substrate 20, the resilient part 128 touches against the device 10 via the opening 126. In other words, the resilient part 128 of the second engaging unit 120 presses the device 10 through the opening 126 so as to restrain the device 10 from moving. It is noted that the resilient part 128 can be formed with various shapes and arranged in various locations. Referring to FIGS. 1C and 1D, the resilient part 128 is disposed on the perimeter of the opening 126 defined by the body 122. The resilient part 128 further includes a hook-like portion 130. When the device 10 and the substrate 20 are assembled, the hook-like portion 130 touches against the device 10 so as to restrain movements of the device 10 and the protrusion 112 of the first engaging unit 110. For example, the hook-like portion 130 presses the device 10 via the opening 126, and the bottom of the hook-like portion 130 touches against the device 10 while the tip end 134 of the hook-like portion 130 is very close to or directly contacts the protrusion 112 of the first engaging unit 110. Therefore, the movement of the protrusion 112 of the first engaging unit 110 is kept between the resilient part 128 and the engaging part 124, and thereby further securing the first engaging unit 110 and the second engaging unit 120 together.

Referring to FIGS. 2A and 2B, a modified fixing apparatus 200 is provided. The apparatus 200 includes a first engaging unit 210 and a second engaging unit 220 similar to those in the first embodiment. The difference lies in that the first engaging unit 210 of the apparatus 200 includes a base 216, which is engaged with the substrate 20. A protrusion 212 is vertically protrudent from the base 216. In this embodiment, the first engaging unit 210 and the substrate 20 are designed to be two individual elements instead of one integral element as illustrated in the first embodiment. The substrate 20 includes a connecting mechanism 22 so as to engage with the first engaging unit 210, thereby being suitable for various kinds of applications. Furthermore, an accommodation space 214 formed in the protrusion 212 is designed to be in arc shape to provide variety with respect to the engaging part 224 of the second engaging unit 220. Furthermore, the engaging unit 220 is optionally formed with an opening 226 and includes a resilient part 228 similar to the first embodiment. The second engaging unit 220 further includes an extension part 230 extending from the body 222 so as to restrain the movement of the device 10 when assembled. The extension part 230 further limits movements of the device 10 and increases the balance between the first engaging unit 210 and the second engaging unit 220, and thereby preventing the second engaging unit 220 from slanting to one side.

It is noted that the length of the protrusion 112 or 212 or the length of the protrusion extending from the substrate is preferably designed with consideration of the thickness of the device 10. Therefore, the thickness of an electronic device can be maintained at a minimum level so as to effectively reduce the undesirable increase in thickness due to the use of the fixing apparatus. Furthermore, when the first and second engaging units are made of metal materials, the body 110 or 210 and the extension part 230 can be formed as a film, thereby effectively reducing the thickness of the apparatus itself. Consequently, the thickness of the assembled device is nearly the total thickness of the substrate and the device. Moreover, as the length of the protrusion 112 or 212 is close to the thickness of the device 10, the size of the through hole 12 is preferably designed with consideration relative to the engagement of the first and the second engaging units.

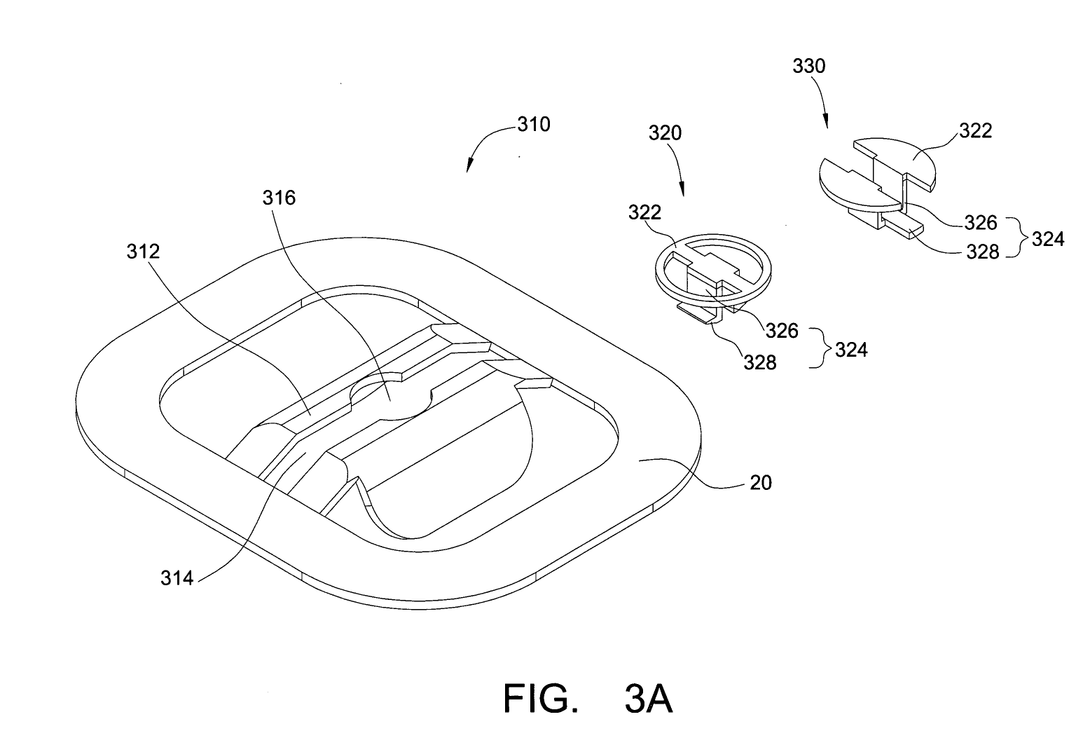

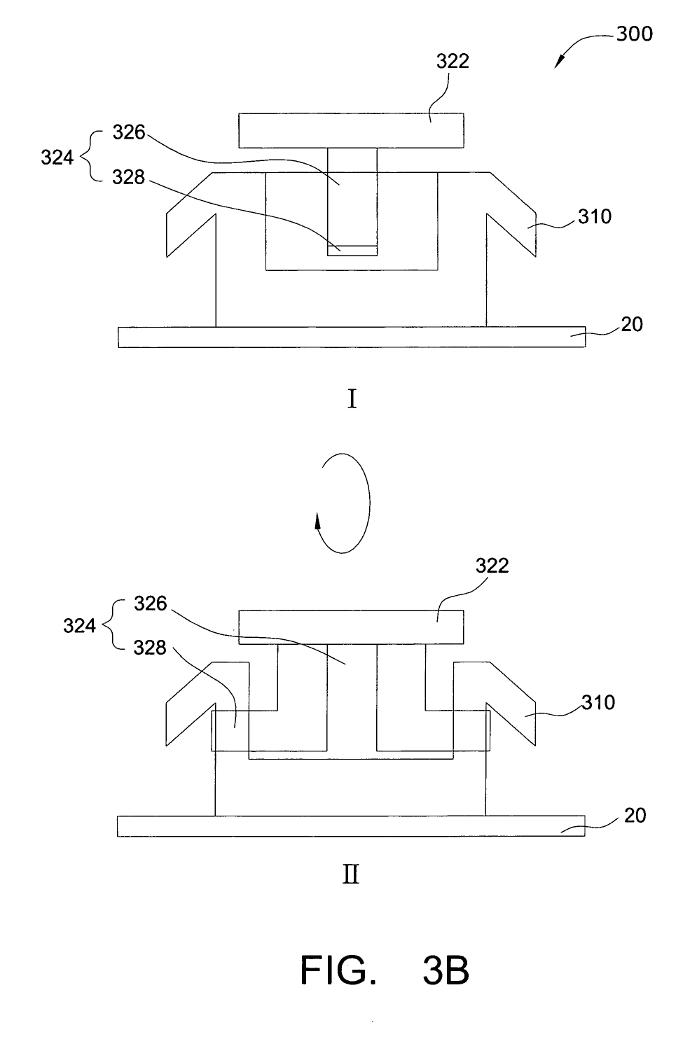

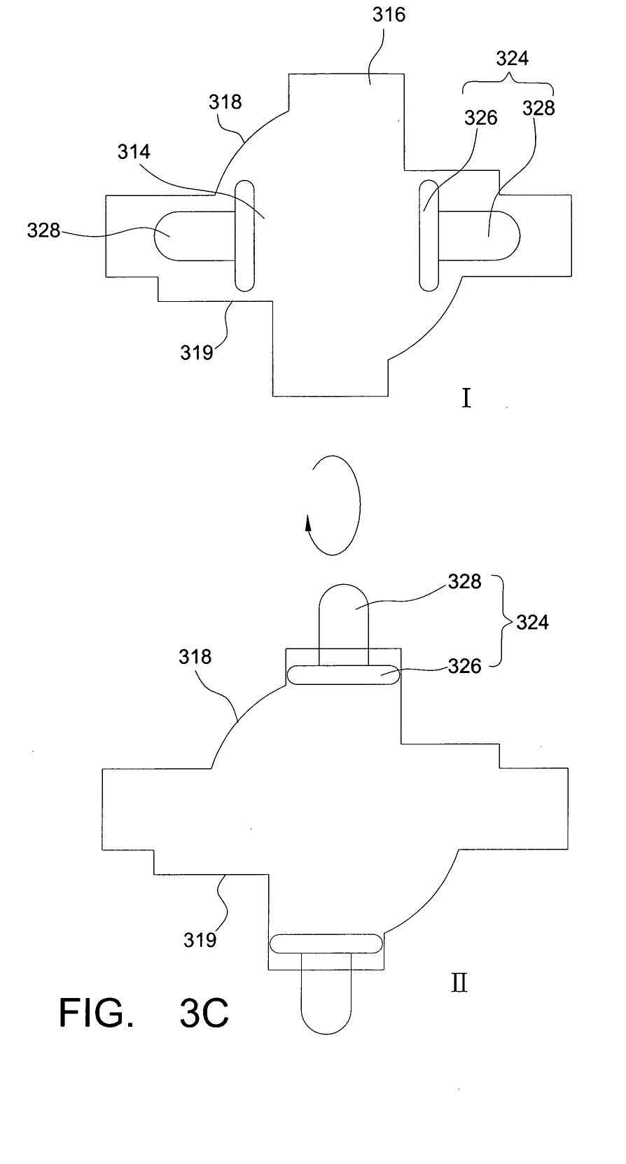

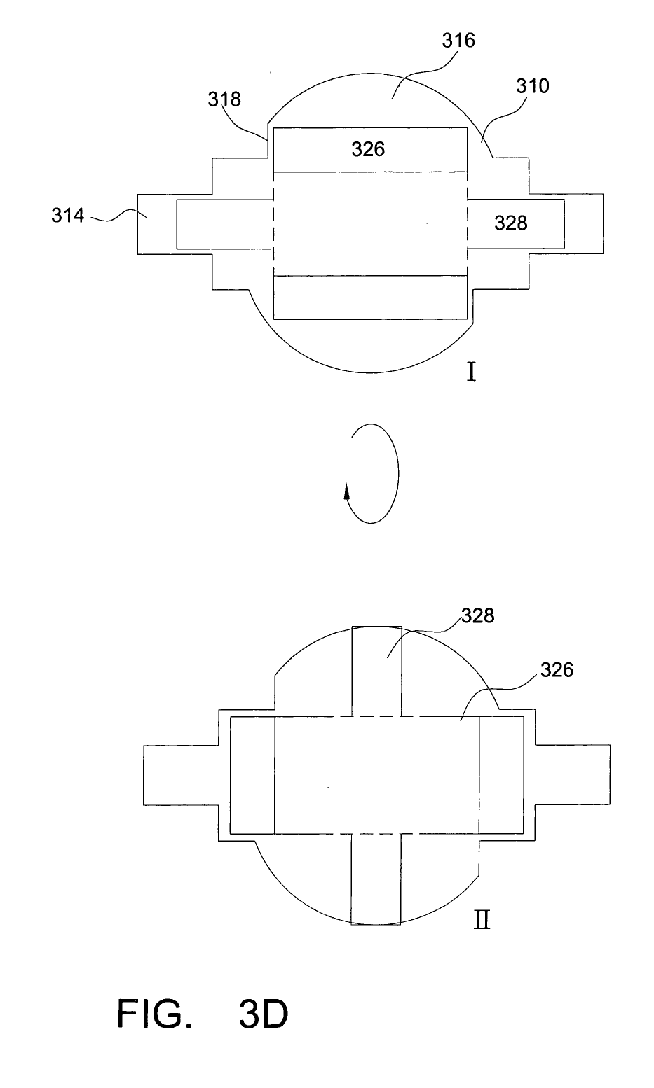

Referring to FIG. 3A, an apparatus 300, in accordance with a second embodiment of the present invention, for assembling a device onto a substrate is provided. The device is similar to that as illustrated in the first embodiment. The apparatus 300 includes a first engaging unit 310 and a second engaging unit 320. The first engaging unit 310 couples to the substrate 20 and includes a protrusion 312. The protrusion 312 has an inner rim defining a first accommodation space 314 and a second accommodation space 316. The second engaging unit 320 includes a body 322 and an engaging part 324, which connects to the body 322. FIGS. 3B and 3C are schematic cross-sectional views illustrating two stages in using the apparatus 300 to assemble the device onto the substrate. When the device is to be assembled onto the substrate, the engaging part 324 of the second engaging unit 320 passes through the through hole of the device and received in the first accommodation space 314 (as shown in drawing I of FIGS. 3B and 3C). Then the engaging part 324 rotates along the inner rim of the protrusion 312 to be received in the second accommodation space 316 so that the device is fixed between the body 322 of the second engaging unit 320 and the substrate 20 (as shown in drawing II of FIGS. 3B and 3C).

Referring to FIG. 3C, the inner rim of the protrusion 312 includes an arc portion 318 and a straight portion 319. The straight portion 319 corresponds to the arc portion 318 and limits the engaging part 324 to rotating along the arc portion 318. In other words, the inner rim of the protrusion 312 is designed to limit the engaging part 324 of the second engaging unit to rotating along a single route, from the first accommodation 314 to the second accommodation space 316 before it is engaged within the second accommodation space 316. Furthermore, the engaging part 324 includes an engaging body 326 and a wing 328. The engaging body 324 connects to the body 322, and the wing 328 is engaged within the second accommodation space 316 when the apparatus is in use.

Alternatively, the engaging part 324 of the second engaging unit 320 is elastically deformable, so that the wing 328 can escape from the second accommodation space 316 to be in the first accommodation space 314 when the first engaging unit 310, the device, and the second engaging unit 320 are to be detached. That is, the first accommodation space and the second accommodation space defined by the inner rim of the protrusion 312 are different in dimension so that the engaging body 326 of the engaging part 324 is deformable in response to the applications of assembly or detachment. Therefore, as the engaging part 324 is received in the first accommodation space 314, the second engaging unit 320 and the first engaging unit 310 are detachable. As the engaging part 324 is received in the second accommodation space 316, the second engaging unit 320 and the first engaging unit 310 are engaged.

It is noted that the first and the second engaging units of the apparatus 300 may have different modifications. As shown in FIGS. 3A and 3D, in an alternative embodiment, a second engaging unit 330 is shaped differently comparing with the second engaging unit 320, but functions similarly. In response to the modification made on the second engaging unit 330, the inner rim of the protrusion of the first engaging unit 310 is accordingly modified, as shown in FIG. 3D. The engaging body 326 of the engaging part 324 of the second engaging unit 330 is also elastically deformable. When the first engaging unit 310 and the second engaging unit 320 are to be engaged, the wing 328 rotates from the first accommodation space 314 to the second accommodation space 316, and the engaging body 326 is elastically deformed so that the engaging part 324 is engaged within the second accommodation space 316.

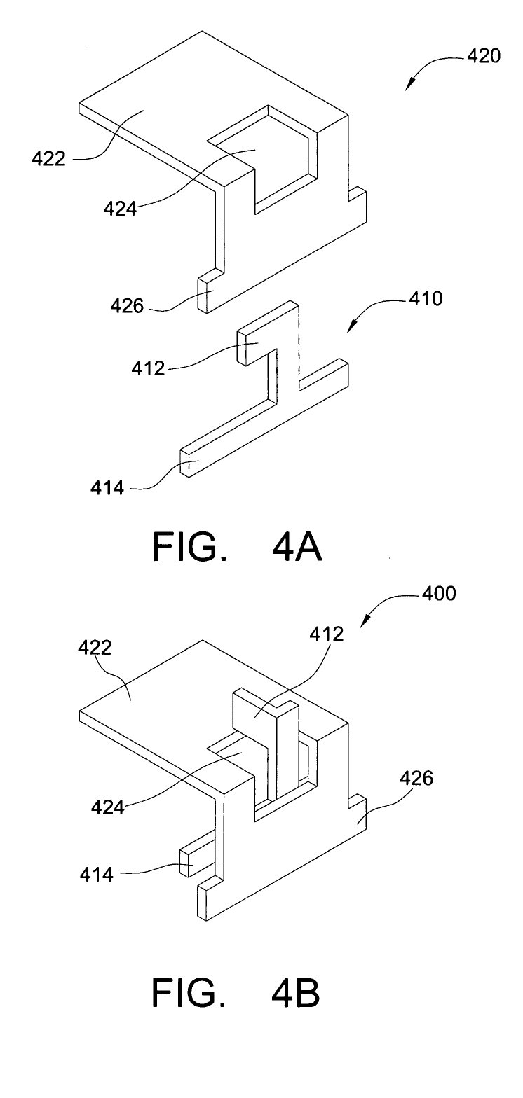

Referring to FIGS. 4A and 4B, an apparatus 400, in accordance with a third embodiment, for assembling a device, which is formed with a through hole, onto a substrate is provided. The device and the substrate are similar to the previous embodiments. The apparatus 400 includes a first engaging unit 410 and a second engaging unit 420. The first engaging unit 410 coupling to the substrate includes a deformable protrusion 412. The second engaging unit 420 includes a body 422, which defines an opening 424. When the device and the substrate are to be assembled, the deformable protrusion 412 of the first engaging unit 410 passes through the through hole of the device and is exposed within the opening 424 of the second engaging unit 420. Then, the deformable protrusion 412 is deformed to limit the movement of the device so that the device is fixed between the body 422 of the second engaging unit 420 and the substrate, as shown in FIG. 4B.

As described above, the first engaging unit 410 may include a base 414 for engaging with the substrate or may be formed integrally with the substrate as one piece. The deformable protrusion 412 includes a hook-like portion protrudently extending from the base 414. The hook-like portion 412 is bent to an angle, such as a 90 degree one, to touch against the device when the device and the substrate are assembled. Furthermore, the opening 424 of the second engaging unit 420 can be designed to correspond to the hook-like protrusion 412, so that the hook-like portion touches against the body 422 of the second engaging unit 420. The body 422 of the second engaging unit 420 further includes an engaging part 426, which can be engaged via the through hole of the device, and thereby restraining movements of the device. In other words, the second engaging unit 420 can be fixed on the device or the substrate by use of the engaging part 426 so as to enhance the strength of the assembly.

Although specific embodiments have been illustrated and described, it will be apparent that various modifications may still fall within the scope of the appended claims.

1. An apparatus for assembling a device, which is formed with a through hole, onto a substrate, comprising:
a first engaging unit coupling to said substrate, said first engaging unit comprising a protrusion defining an accommodation space; and
a second engaging unit comprising a body and an engaging part, said engaging part being connected to said body,
wherein said protrusion passes through said through hole, and said engaging part is received in said accommodation space so that said device is fixed between said body and said substrate when said device and said substrate are assembled.

2. The apparatus of claim 1, wherein said accommodation space is a hole formed in said protrusion.

3. The apparatus of claim 2, wherein said hole is in a rectangular shape or an arc shape.

4. The apparatus of claim 1, wherein said first engaging unit comprises a base coupling to said substrate, and said protrusion is protrudent from said base.

5. The apparatus of claim 1, wherein said first engaging unit and said substrate are integrally formed, and said protrusion is protrudent from said substrate.

6. The apparatus of claim 1, wherein said body of said second engaging unit defines an opening, and said second engaging unit further comprises a resilient part coupling to said body, and said resilient part touches against said device via said opening when said device and said substrate are assembled.

7. The apparatus of claim 6, wherein said resilient part comprises a hook-like portion, and said hook-like portion touches against said device so as to restrain the movement of said protrusion of said first engaging unit when said device and said substrate are assembled.

8. The apparatus of claim 1, wherein said second engaging unit further comprises an extension part extending from said body so as to restrain the movement of said device.

9. An apparatus for assembling a device, which is formed with a through hole, onto a substrate, comprising:
a first engaging unit coupling to said substrate, said first engaging unit comprising a protrusion, said protrusion having an inner rim defining a first accommodation space and a second accommodation space; and
a second engaging unit comprising a body and an engaging part, said engaging part being connected to said body,
wherein said engaging part passes through said through hole of said device and received in said first accommodation space, and said engaging part rotates along said inner rim to be received in said second accommodation space so that said device is fixed between said body of said second engaging unit and said substrate when said device and said substrate are assembled.

10. The apparatus of claim 9, wherein said inner rim comprises an arc portion and a straight portion, and said straight portion corresponds to said arc portion and limits said engaging part to rotating along said arc portion.

11. The apparatus of claim 9, wherein said engaging part comprises an engaging body and a wing, said engaging body connects to said body, and said wing is engaged within said second accommodation space.

12. The apparatus of claim 11, wherein said engaging part of said second engaging unit is elastically deformable, so that said wing leaves said second accommodation space to be in said first accommodation space when said first engaging unit, said device, and said second engaging unit are to be detached.

13. An apparatus for assembling a device, which is formed with a through hole, onto a substrate, comprising:
a first engaging unit coupling to said substrate, said first engaging unit comprising a deformable protrusion; and
a second engaging unit comprising a body defining an opening,
wherein said deformable protrusion of said first engaging unit passes through said through hole of said device and is exposed within said opening of said second engaging unit, and said deformable protrusion is deformed to limit the movement of said device so that said device is fixed between said body of said second engaging unit and said substrate when said device and said substrate are assembled.

14. The apparatus of claim 13, wherein said first engaging unit comprises a base coupling with said substrate, and said deformable protrusion comprises a hook-like portion protrudently extending from said base, and said hook-like portion is bent to an angle to touch against said device when said device and said substrate are assembled.

15. The apparatus of claim 13, wherein said first engaging unit and said substrate are integrally formed, and said deformable protrusion is protrudent from said substrate.

16. The apparatus of claim 13, wherein said body of said second engaging unit comprises an engaging part, and said engaging part is engaged with said through hole of said device so as to restrain a movement of said device.
